(19) United States
(12) Patent Application Publication
(10) Pub. No.: US 2010/0173537 A1
(43) Pub. Date: Jul. 8, 2010

(54) Field Installed Lug Landing Accessory

(75) Inventors: Kristopher Scott Robinson, Atlanta, GA (US); Jeffrey K. Hudgins, JR., Gainesville, GA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Industry, Inc., Alpharetta, GA (US)

(21) Appl. No.: 12/652,328

(22) Filed: Jan. 5, 2010

Related U.S. Application Data
(60) Provisional application No. 61/142,693, filed on Jan. 6, 2009.

(51) Int. Cl. H01R 4/30; H01R 11/11

(52) U.S. Cl. 439/801; 439/883

(57) ABSTRACT

The present invention relates generally to a lug landing accessory. More particularly, the invention encompasses a field installed lug landing accessory. The present invention is also directed to a novel lug landing kit that can be installed by an installer in the field. The invention further comprises a lug coupler comprising a set of bus bars, each of the set of the bus bars are secured to an electrically non-conductive housing of the lug coupler. The bus bar has at least one opening for the passage of at least one electrically conductive protrusion, and the bus bars are electrically connected to at least one corresponding breaker strap.

### CROSS-REFERENCE TO RELATED APPLICATION

The instant patent application claims priority to and the benefit of pending U.S. Provisional Patent Application Ser. No. 61/142,693, filed on Jan. 6, 2009, titled “Field Installed Lug Landing Accessory,” the entire disclosure of which provisional application is incorporated herein by reference.

### FIELD OF THE INVENTION

The present invention relates generally to a lug landing accessory. More particularly, the invention encompasses a field installed lug landing accessory. The present invention is also directed to a novel lug landing kit that can be installed by an installer in the field. The invention further comprises a lug coupler comprising a set of bus bars, each of the set of the bus bars are secured to an electrically non-conductive housing of the lug coupler. The bus bar has at least one opening for the passage of at least one electrically conductive protrusion, and the bus bars are electrically connected to at least one corresponding breaker strap.

### BACKGROUND INFORMATION

During the installation process of many modular panel boards, it becomes necessary for some applications to be electrically connected to the modular panel boards with specific connectors and/or lugs. In the case of existing units, a kit or means to easily or affordably provide such an electrical connection does not exist. For some applications the installers usually purchase a separate panel board accessory that mounts next to a standard unit so these specific connectors can be installed. This additional separate panel board unit or accessory takes up precious wall space. In some cases the installers prefer not to give up that extra wall space or in other situations there many not be extra wall space available in the vicinity of the modular panel board. Other manufacturers have their own solution to solve this problem. Some manufacturers have overcome the wall space issue, but they have put a burden on the supply chain in order to build these special units, while at the same time supporting a standard line of product.

Therefore there is a need for improvement in a lug landing accessory and in particular a field installed lug landing accessory.

U.S. Pat. No. 5,989,073 (Scott D. Kahoun), the entire disclosure of which is incorporated herein by reference, discloses a power block including an insulative block which is mounted to a panel and a plurality of connection mounts which are coupled to the insulative block. The insulative block includes a plurality of molded dividers and the connection mounts are located therebetween. Each connection mount includes at least one stud extending upward from the block and a conductor having first and second portions. The first portion of each conductor is conductively coupled to the one or more studs and the second portion extends through the block in a direction opposite the one or more studs. The second portion includes a free end provided with a connector directly couplable to a destination point. A preferred aspect of the invention is that the conductor is a copper braid partially covered in a tin plated copper sleeve. According to a first embodiment, the connector at the free end of the conductor is a sleeve extending over the free end and having a hole for directly receiving a lead from a power filter. According to a second embodiment, the second portion of the conductor is formed of solid copper and the connector is a tapered free end of the second portion of the conductor which is “pluggable” into resilient clips. According to a third embodiment, the second portion of the conductors are substantially elongate and flexible, and the connector at the free end is a sleeve having a coupling slot or hole.

U.S. Pat. No. 6,379,196 (Randy Greenberg, et al.), the entire disclosure of which is incorporated herein by reference, discloses a termination connector for a circuit breaker. The termination connector preferably includes a plurality of single pole screw receiving members integrally attached by a molded housing for unitary attachment to a line or load end of a circuit breaker to assist in holding a nut or nut plate adjacent each screw hole in the circuit breaker's terminal straps. The molded housing preferably includes a line of perforations between each single pole screw receiving member so that the correct number of single pole screw receiving members can be retained and the others can be knocked off along the line of perforations. Provisions are disclosed for adaptation of the connector to metric or English standard nut hardware. In addition, the termination connector and circuit breaker are provided with mating attachment devices for providing a simple yet secure connection.

U.S. Pat. No. 7,578,711 (Kristopher Scott Robinson), the entire disclosure of which is incorporated herein by reference, discloses certain exemplary embodiments that can provide a system, which can comprise a lug coupler that comprises a set of bus bars. Each of the set of bus bars can be adapted to be releasably attached to a corresponding terminal of a set of terminals of a circuit breaker. The system can comprise a set of studs adapted to engage a corresponding set of apertures defined by an end connector of one of a set of electrical leads adapted to be electrically coupled to the lug coupler.

However, this invention overcomes the problems and deficiencies of the known art and provides an inventive field installed lug landing accessory, which can be easily field installed on a standard line of panel board accessories. This invention also resolves any supply chain burden and provides the installer with a product that they can electrically connect to with their specific connector and/or lugs. This inventive accessory also complies with all agency requirements, i.e., UL, for use in the product in which this inventive accessory can be field installed.

### PURPOSES AND SUMMARY OF THE INVENTION

The invention is a novel field installed lug landing accessory.

Therefore, one purpose of this invention is to provide a field installed lug landing accessory.

Another purpose of this invention is to provide a reliable solution for field installing lugs.

Yet another purpose of this invention is to provide a robust lug landing kit that can be field installed.

Therefore, in one aspect this invention comprises a lug landing pad apparatus, comprising:

a lug coupler comprising a set of bus bars, each of said set of bus bars secured to an electrically non-conductive housing of said lug coupler, said bus bar having at least one opening for the passage of at least one electrically conductive protrusion, said bus bar electrically connected to at least one corresponding breaker strap, and thereby forming said lug landing pad apparatus.

In another aspect this invention comprises a lug landing pad apparatus, comprising:

a lug coupler comprising a set of bus bars, each of said set of bus bars snapably connected, via an engagement of at least one bus bar snap, to an electrically non-conductive housing of said lug coupler, said bus bar having at least one opening for the passage of at least one electrically conductive protrusion, said bus bar electrically connected to at least one corresponding breaker strap, and thereby forming said lug landing pad apparatus.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1 illustrates a front isometric view of the completed lug landing pad assembly of a first embodiment of this invention.

FIG. 2 illustrates a side view of the completed lug landing pad assembly of the embodiment of this invention as illustrated in FIG. 1.

FIG. 3 illustrates a rear isometric view of the completed lug landing pad assembly of the first embodiment of this invention as illustrated in FIG. 1.

FIG. 4 is a detailed view showing the detail 4, from FIG. 3, which is an enlarged view showing the bus bar snap of this invention engaged with an edge of the bus bar.

FIG. 5 is a detailed view showing the detail 4, from FIG. 3, which is an enlarged view showing the bus bar snap of this invention but without the bus bar.

FIG. 6 illustrates a detailed cut-away view of a second embodiment of this invention illustrating in detail the profile of the A, B, and C phase cavities along with the corresponding bus bars and bus bar snaps.

### DETAILED DESCRIPTION

The inventive field installed lug landing pad accessory of this invention provides an alternative wiring option for contractors, electricians, or anyone who might install a circuit breaker in a standard panel board accessory. This inventive lug landing pad accessory can be field installed during the installation process, and it provides the convenience of installing compression or mechanical/pressure connectors and/or lugs on a standard line of panel board accessories.

It should also be appreciated the way in which this lug landing pad accessory is assembled. The conservation of wall space, especially the width of the unit, during the installation process which is rather important in this industry is also achieved with this invention. This inventive lug landing pad accessory has been designed to minimize width, as required for multiple studs per phase arrangements. In addition to this, this inventive lug landing pad accessory design reduces the metal scrap associated with connecting multiple studs per phase arrangement bussing to a circuit breaker. This is achieved by forming the circuit breaker connecting bus in a z shape and having a second set of connector/lug connecting bus (out of the same material or a different material) also formed in a z shape attached to one another. Mechanically fastening these two z shaped bus bars of this invention allows the current path to change from a direction that is parallel to the bussing of the circuit breaker to a direction that is perpendicular to the circuit breaker. All of this is achieved using standard width bussing and without creating any scrap material.

It should be understood that all of the phase bussing is coupled together by the use of a lug landing base or pad. This lug landing pad is made out of a non-electrically conductive material, such as, for example, plastic. The bus bars are fastened to the plastic base by the use of securing means, such as, snaps. Mechanical fasteners for attaching connectors and/or lugs to the bus are also retained by the lug landing base. This inventive assembly preferably travels as a kit and preferably contains no loose parts. This inventive kit makes it very easy to convert a standard circuit breaker unit to one that will accept the specific connectors and/or lugs as required by some of the customers or applications.

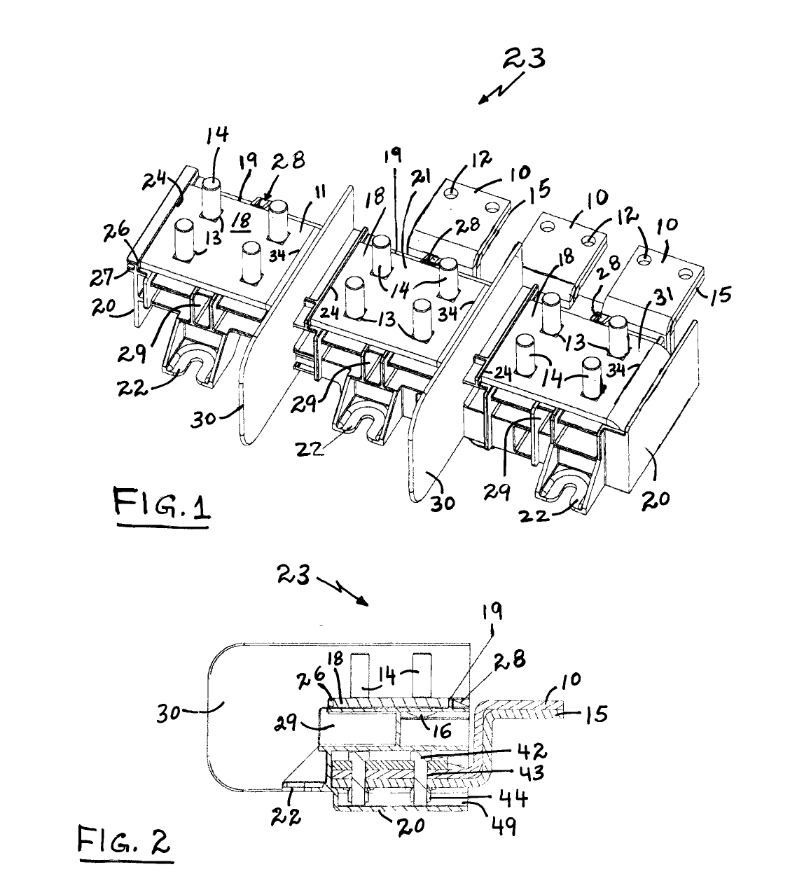

FIG. 1 illustrates a front isometric view of a completed lug landing pad assembly or kit or apparatus 23, of a first embodiment of this invention. This completed lug landing pad assembly or kit or apparatus 23, has a support base or an electrically non-conductive housing 20, at least one electrically conductive protrusion 14, such as, a stud 14, and at least one bus bar 18. To assemble a bus bar 18, to the support base 20, one could simply slide the bus bar 18, in the appropriate support base phase cavity until at least one bus bar snap 28, engages with at least one bus bar edge 19, of the bus bar 18, as more clearly illustrated with reference to FIG. 4. The electrically non-conductive housing 20, has at least one mounting tab or feet 22, which can be used to secure the lug landing apparatus 23, to a modular panel board (not shown). It is preferred that the bus bar snap 28, has an open area or bus bar snap cavity or opening 29, so as to allow the bus bar snap 28, to be able to move vertically when it either engages or disengages from the bus bar edge 19. In order to further secure or strengthen the electrically non-conductive housing 20, one could have at least one rib or strengthening feature 27. For most applications it is preferred that the bus bar 18, has at least one opening 13, to allow for the passage of the stud 14. It is preferred that the stud 14, is a NEMA stud 14. The electrically non-conductive housing 20, is also preferably provided with at least one bus bar rail or track 24, 34, which allow for the sliding motion of the bus bar 18, into and out of the electrically non-conductive housing 20. The bus bar rail or track 24, tracks or holds one edge of the bus bar 18, while the bus bar rail or track 34, tracks or holds the opposite edge of the bus bar 18. In order to control or stop the movement of the bus bar 18, along the bus bar rail or track 24, 34, the electrically non-conductive housing 20, could also have at least one bus bar stop 26. It is preferred that the bus bar stop 26, works in conjunction with the bus bar snap 28, this way when the bus bar 18, is positioned into the electrically non-conductive housing 20, the bus bar stop 26, stops the movement of the bus bar 18, at one end of the bus bar 18, while the other end or the bus bar edge 19, is engaged by the bus bar snap 28. The electrically non-conductive housing 20, can also have at least one insulation phase barrier or isolation tab 30, to electrically insulate or isolate the various bus bar 18, phases, such as, for example, A-Phase bus bar 11, B-Phase bus bar 21, C-Phase bus bar 31. The lug landing apparatus 23, is also provided with at least one breaker strap 10. For some applications it is preferred that the breaker strap 10, has at least one breaker strap laminate 15. The breaker strap 10, could also have at least one hole or opening 12, for securing means (not shown), such as, a screw, a bolt, a rivet, to name a few. For some applications the breaker strap 10, having the breaker strap laminate 15, helps in heat sink purposes. For some applications the mounting feet or tab 22, can also be used for fastening or securing the lug landing apparatus 23, to at least one mounting bracket in the main breaker enclosure (not shown).

FIG. 2 illustrates a side view of the completed lug landing pad assembly 23, of the embodiment of this invention as illustrated in FIG. 1. As one can see that the bus bar 18, is held in place at one end by the bus bar stop 26, and by the bus bar snap 28, at the opposite end. It is preferred that the stud 14, has a head or a similar feature 16, which is securely held inside the electrically non-conductive housing 20. The stud 14, could also be carriage bolt 14, having a head 16. The breaker strap 10, along with the breaker strap laminate 15, is electrically connected to the bus bar 18, and is securely held inside the electrically non-conductive housing 20, via at least one securing means 42. The securing means 42, could be a fastener, a hex bolt fastener, a rivet, a weld, to name a few. As illustrated in FIG. 2, the securing means 42, passes through an opening or hole 43, in the bus bar 18, and the breaker strap 10, and is secured to another fastening means 44. The fastening means 44, could be a nut, a hex nut, a rivet, a weld, to name a few. It is preferred that the electrically non-conductive housing 20, has at least one cavity 49, to accommodate the securing means 42, the fastening means 44, and the related components that are secured via the securing means 42, and the fastening means 44.

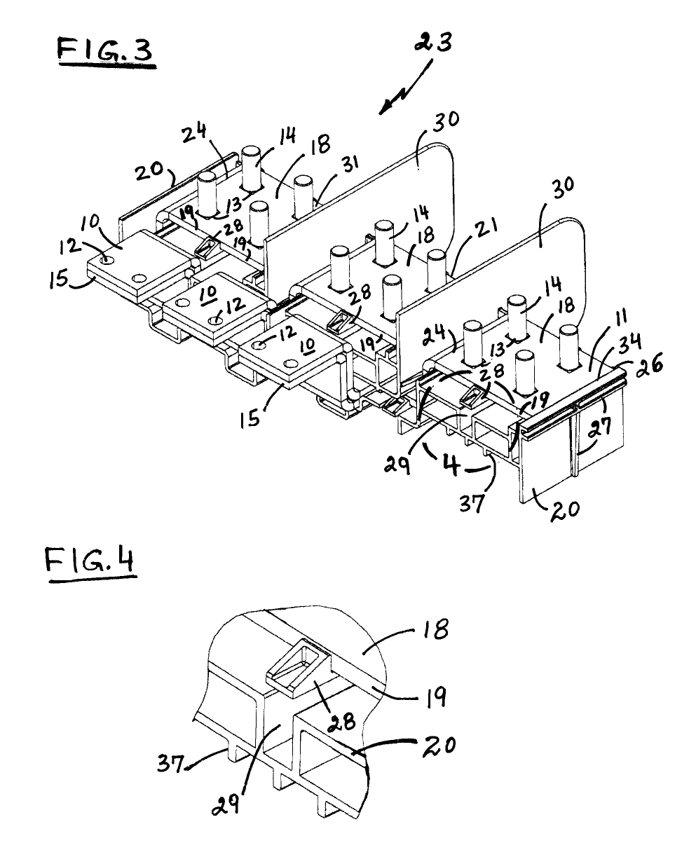

FIG. 3 illustrates a rear isometric view of the completed lug landing pad assembly 23, of the first embodiment of this invention as illustrated in FIG. 1. As one can see that the bus bar 18, is held on one side via the bus bar snap 28, while the two adjacent sides of the bus bar 18, are held within the bus bar rail or track 24, 34, and the forth edge of the bus bar 18, is held in place via the bus bar stop 26. The enlarged view of the bus bar snap area or detail 4 is more clearly shown with reference to FIG. 4. The ribs 27, can also be strengthening ribs 27, which can be used to prevent the movement of the bus bar 18, especially, during the application of tightening torque on the connector studs 14. The electrically non-conductive housing 20, can also be provided with at least one rib 37, to further strengthen the electrically non-conductive housing 20.

FIG. 4 is a detailed view showing the detail 4, from FIG. 3, which is an enlarged view showing the bus bar snap 28, of this invention engaged with an edge 19, of the bus bar 18. As one can see that the electrically non-conductive housing 20, has a bus bar snap cavity or opening 29, to allow pivotal movement of the bus bar snap 28, when it is used to either engage or disengage from the bus bar 18. The ribs 37, can also be strengthening ribs 37, which can be used to prevent cracking of the base of the electrically non-conductive housing 20, especially, during the application of tightening torque on the connector studs 14. For some applications the rib 37, can also be used as a spacer 37.

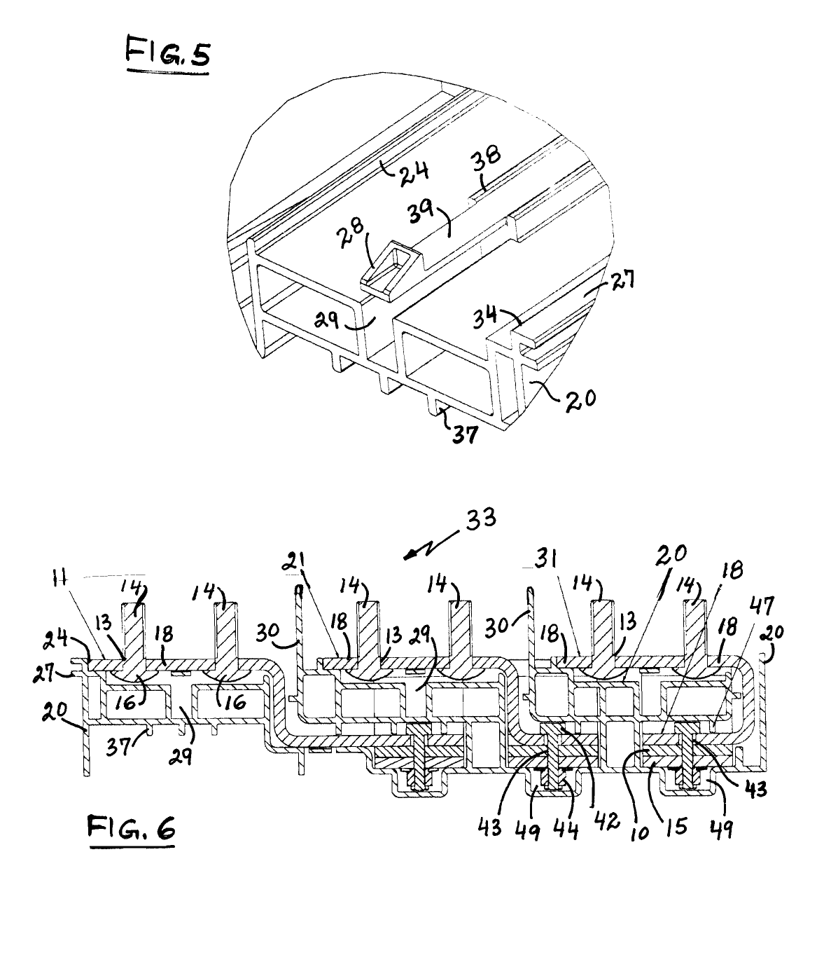

FIG. 5 is a detailed view showing the detail 4, from FIG. 3, which is an enlarged view showing the bus bar snap 28, of this invention but without the bus bar 18. The bus bar snap 28, preferably has a bus bar snap extension 39, which is held in place via rib or bus bar snap rail 38. The bus bar snap extension 39, could also be secured or welded to the rib or bus bar snap rail 38. The bus bar snap extension 39, allows for the pivotal movement of the bus bar snap 28. For some applications the rib or bus bar snap rail 38, could also be used as a spacer 38, or as a resting surface 38, for resting or holding the surface of the bus bar 18. For some applications the rib or bus bar snap rail 38, could be strengthening ribs 38, to further strengthen the electrically con-conductive housing 20. The bus bar rail or track 24, 34, can be a channel like feature 24, or a flat step like surface 34, or just a flat wall surface 24, 34.

FIG. 6 illustrates a detailed cut-away view of a second embodiment 33, of this invention illustrating in detail the profile of the A, B, and C phase cavities along with the corresponding bus bars 18, and bus bar snaps 28. Also shown in FIG. 6 is the phase stud arrangement and bus hardware used in this particular embodiment 33. Bus hardware is optional and could be replaced with welds or other fastening methods. The construction of the embodiment 33, shown in FIG. 6 consists of at least two sets of studs 14, per phase. The number of sets of studs 14, is dependent on the amperage required for the end use. To clarify, there are preferably two studs 14, per set, and a set includes at least one stud 14, assembled towards the front of the lug landing pad assembly, and one towards the back of the lug landing pad assembly. It should be appreciated that A-phase bus bar 11, is electrically connected to an A-phase breaker strap 10, while a B-phase bus bar 21, is electrically connected to a B-phase breaker strap 10, and the C-phase bus bar 31, is electrically connected to a C-phase breaker strap 10. For some applications the electrically non-conductive housing 20, could have at least one rib 47. The rib 47, can be used as a spacer 47. The rib 47, can also be used to strengthen the electrically non-conductive housing 20.

The electrically non-conductive housing 20, is made from a material, such as, for example, nylon, polytetrafluoroethylene (PTFE), plastic, electrically non-conductive material, electrically non-conductive composite material, to name a few.

The breaker strap 10, the stud 14, the bus bar 18, are made from an electrically conductive material, such as, for example, copper, aluminum, silver, electrically conductive metallic material, electrically conductive composite material, to name a few.

It should be appreciated that the embodiments are shown in a three-phase electrical configuration, however, a person skilled in the art can easily modify the lug landing apparatus 23, 33, into a single-phase configuration, such as, by not installing center bus lugs.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A lug landing pad apparatus, comprising:
a lug coupler comprising a set of bus bars, each of said set of bus bars secured to an electrically non-conductive housing of said lug coupler, said bus bar having at least one opening for the passage of at least one electrically conductive protrusion, said bus bar electrically connected to at least one corresponding breaker strap, and thereby forming said lug landing pad apparatus.

2. The lug landing pad apparatus of claim 1, wherein at least one bus bar is snapably secured to said electrically non-conductive housing.

3. The lug landing pad apparatus of claim 1, wherein at least one bus bar is secured to said electrically non-conductive housing via at least one securing means, and wherein said at least one securing means is selected from a group consisting of a weld, rivet, screw, and a bolt.

4. The lug landing pad apparatus of claim 1, wherein each of said set of bus bars is releasably attached to a corresponding terminal of a set of terminals of a circuit breaker.

5. The lug landing pad apparatus of claim 1, wherein said at least one breaker strap has at least one opening for a securing means.

6. The lug landing pad apparatus of claim 1, wherein said at least one breaker strap has at least one opening for a securing means, and wherein said securing means is selected from a group consisting of a weld, a rivet, a screw, and a bolt.

7. The lug landing pad apparatus of claim 1, wherein said bus bar is securely held in place in said electrically non-conductive housing via at least one securing means at one end, and at least one bus bar stop at the opposite end of said bus bar.

8. The lug landing pad apparatus of claim 1, wherein said bus bar is securely held in place in said electrically non-conductive housing via at least one securing means at one end, and at least one bus bar stop at the opposite end of said bus bar, and wherein said at least one securing means is selected from a group consisting of a bus bar snap, weld, a rivet, a bolt and a screw.

9. The lug landing pad apparatus of claim 1, wherein said at least one electrically conductive stud is secured to said bus bar via at least one securing means.

10. The lug landing pad apparatus of claim 1, wherein said at least one electrically conductive protrusion is selected from a group consisting of a rivet, a screw, a stud, and a bolt.

11. The lug landing pad apparatus of claim 1, wherein said at least one electrically conductive protrusion is secured to said bus bar via at least one securing means, and wherein said at least one securing means is selected from a group consisting of a weld, and a securing head at a first end of said at least one electrically conductive protrusion, and wherein said securing head is sandwiched between said bus bar and said electrically non-conductive housing.

12. The lug landing pad apparatus of claim 1, further comprising a circuit breaker.

13. The lug landing pad apparatus of claim 1, further comprising a set of electrical leads.

14. The lug landing pad apparatus of claim 1, wherein said electrically non-conductive housing has at least one means to electrically isolate any pair of electrical leads releasably attachable to said lug coupler.

15. The lug landing pad apparatus of claim 1, wherein said electrically non-conductive housing has at least one mounting tab to secure said electrically non-conductive housing to a panel board.

16. The lug landing pad apparatus of claim 1, wherein said electrically non-conductive housing has a bus bar snap cavity to allow for vertical movement of a corresponding bus bar snap.

17. The lug landing pad apparatus of claim 1, wherein said electrically non-conductive housing has at least one rib to support a corresponding bus bar.

18. The lug landing pad apparatus of claim 1, wherein said electrically non-conductive housing has at least one rib to support a corresponding bus bar snap.

19. The lug landing pad apparatus of claim 1, wherein a first end of a bus bar snap is secured to a corresponding rib, while a second end of said bus bar snap has at least one protrusion to engage an edge of a corresponding bus bar.

20. The lug landing pad apparatus of claim 1, wherein said electrically non-conductive housing is made from a material selected from a group consisting of nylon, polytetrafluoroethylene (PTFE), plastic, electrically non-conductive material, and electrically non-conductive composite material.

21. The lug landing pad apparatus of claim 1, wherein said breaker strap, said electrically conductive protrusion, and said bus bar is made from an electrically conductive material, and wherein said electrically conductive material is selected from a group consisting of copper, aluminum, silver, electrically conductive metallic material, and electrically conductive composite material.

22. A lug landing pad apparatus, comprising:
a lug coupler comprising a set of bus bars, each of said set of bus bars snapably connected, via an engagement of at least one bus bar snap, to an electrically non-conductive housing of said lug coupler, said bus bar having at least one opening for the passage of at least one electrically conductive protrusion, said bus bar electrically connected to at least one corresponding breaker strap, and thereby forming said lug landing pad apparatus.
